(19) United States
(12) Patent Application Publication
(10) Pub. No.: US 2009/0254946 A1
(43) Pub. Date: Oct. 8, 2009

(54) Click-through television advertising

(76) Inventor: Peter Samuel Vogel, Faulconbridge (AU)

Correspondence Address: PETER VOGEL, 30 ADELINE STREET, FAULCONBRIDGE, 2776, AU

(21) Appl. No.: 12/419,296

(22) Filed: Apr. 7, 2009

(30) Foreign Application Priority Data
Apr. 8, 2008 (AU) 2008901672

(51) Int. Cl. H04N 5/445

(52) U.S. Cl. 725/60

(57) ABSTRACT

An indicator appears on a TV screen when additional information is available about items in the scene being viewed. If the viewer presses an “info” button the action freezes and an overlay appears on the picture highlighting one or more products for which additional advertising is available. If the viewer moves the cursor to the item of interest and presses “OK”, an advertisement offering additional information about the cursored item plays or other information is displayed, such as special offers, links to retailer's website, opportunity to purchase etc. Similarly, when the credits roll at the end of a show, the viewer can press the “info” button and the credits freeze. A cursor appears on the first item in the credits. This cursor can be navigated around the credits to items that have links attached. If the user presses “OK” they are taken to the website of the credited body, or a prerecorded ad is played off hard disk. In some cases the frozen scene can be partly or completely replaced by a graphic or an animation.

### FIELD OF THE INVENTION

The present invention relates to interactive television and interactive television advertising.

### BACKGROUND OF THE INVENTION

Interactive television advertising invites the television viewer to obtain more information, play games, order products, or interact with television programming in other ways.

One example of interactive advertising is known as “the red button”. An icon appears on screen during commercials or programs, and when the icon appears the viewer can press the red button on their remote control to be shown additional information. In some cases, where the TV receiver has a back channel to an information server, such as via the Internet, the red button takes the viewer to a website.

Such prior art systems have typically been implemented using digital TV middleware such as MHP or MHEG and the software to achieve the interactivity must be authored in advance of broadcast and the appropriate data transmitted with the program.

### SUMMARY OF THE INVENTION

It is an object of the present invention to provide an improved interactive television system which allows any item within a televised scene to be used as a link to further information.

It is a further object of the invention to provide an improved interactive television system which does not require ancillary information to be broadcast with the program providing the link items.

Yet another object of the invention is to provide an improved interactive television system which allows the interactive features to be customised according to the interests or needs of individual viewers.

In one aspect, the present invention provides an interactive television method comprising the steps of displaying a television program, displaying an information icon, receiving an information command from a viewer of said program, freezing display of said program, superimposing an image indicating selectable fields on one or more items of the image on said frozen display, receiving navigation commands from the viewer, moving a cursor between said selectable fields according to said received navigation commands, receiving a confirmation command from the viewer, and, responsive to which selectable field is selected by said cursor, displaying supplementary information.

In some embodiments of the invention, data used for synchronising the information icon to the displayed television program is transmitted simultaneously with the television program. In other embodiments the data is retrieved from a remote server before or after the transmission of the associated program.

In some embodiments of the invention, data used for generating said superimposed image and for linking selectable fields to supplementary information is transmitted simultaneously with the television program. In other embodiments the data is retrieved from a remote server before or after the transmission of the associated program.

In one extension of the invention, on command from a viewer, the video footage at that point is partly or entirely overwritten by text and/or graphics, still or animated, generated by the invention. In some cases the graphic or animation can mimic the live action scene.

The invention also consists in apparatus adapted to perform the steps of the invention.

### DESCRIPTION OF PREFERRED EMBODIMENTS

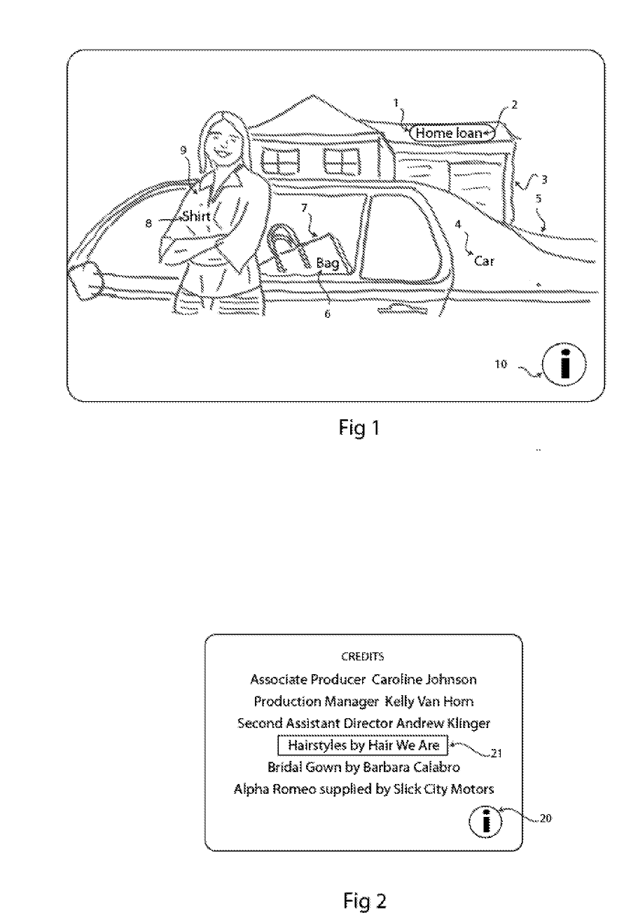

Embodiments of the invention will now be described with reference to the drawings in which: FIG. 1 is an illustration of the invention applied to a scene within a television program; and FIG. 2 is an illustration of the invention applied to the closing credits of a television program.

Referring now to FIG. 1, a scene from a television program including a house, a car and a person is depicted. In this example, this scene appears at exactly 1 minute from the start of the program. The program has been previously recorded off-air by a digital video recorder (DVR) embodying the present invention. The viewer has selected this program for viewing and the DVR has started replaying the appropriate file.

The DVR is connected to the internet, and as soon as the program is selected, software within the DVR causes a request to be sent to a remote server via the internet. The request causes the remote server to interrogate a database to check whether any ancillary data is available for the program being played. In this example such data exists and the server sends the data to the requesting DVR.

The data received by the DVR includes a table indicating the time offsets within the recording at which supplementary information is available, as well as the information itself. In this example, the first information point is at 1 minute. When replay approaches 1 minute, say at 55 seconds, the invention causes information icon 10 to be displayed in the corner of the picture.

If the viewer takes no action, the invention will simply remove the icon after 10 seconds and replay of the program continues until another information point (if any) is reached at which point the process is repeated. If, however, the viewer presses a designated button, for example an “i” button on the DVR's remote controller, replay of the program is suspended, showing a freeze-frame.

The invention then retrieves from the table ancillary data defining the location and form of linking information which the invention then superimposes on the frozen image. In the example of FIG. 1 four items within the scene are linked—the house (3), car (5), bag (7) and shirt (9). Accordingly labels 2, 4, 6, and 8 are displayed adjacent to these items. A cursor indicating which of these items is selected is also displayed, in FIG. 1 the “Home loan” label (2) is highlighted by cursor (1).

It will be understood that although in this example linkable items are indicated by a descriptive text label, it is anticipated that in other cases the linkable items will be indicated in other ways, for example by an outline around the item, highlight, or any other technique which indicates the presence of a special “clickable” field within the picture.

The viewer uses the remote control to drive the cursor from one linkable item to another until one of interest is highlighted. The viewer then presses the appropriate button, such as “ok”, to initiate a request for information about that linkable item. Having identified the supplementary data location definition corresponding to the cursored linkable item, the invention displays the target supplementary information, which can be a website, a locally-stored advertisement, or any other related information. Of course the viewer can also interact with such information, for example to order goods.

Once the viewer has finished looking at or interacting with the supplementary information, they can return to watching the program by pressing the appropriate button, such as “stop”, on the remote control.

As the program progresses, icon 10 may appear from time to time, inviting the viewer to explore further supplementary information.

Referring now to FIG. 2, another exemplary application of the invention will be described. In this example, the invention is applied to the closing credits of a television program. In this case the “i” icon 20 appears when the credits roll at the end of the program, and if the viewer presses the “i” button, the credits freeze and a cursor appears around one of the lines of text of the credits. The viewer can then drive cursor 21 to a credit of interest, in this case to find out more about the hairstyles.

It will be understood that while the invention has been described with reference to particular embodiments, many variations can be made without departing from the scope of the invention.

In one extension of the invention, when the “i” button is pressed, the video footage at that point is entirely overwritten by text and/or graphics generated by the invention, which could for example be defined by HTML, or replaced by a graphic such as a Flash (trademark of Adobe Systems Incorporated) animation. In some cases the graphic or animation can mimic the live action scene. For convenience, the sound of the program can continue playing unaltered, thereby providing a pleasing viewing experience while providing enhanced credits. Furthermore the generated graphic can replace only part of the picture rather than all of it.

It is also envisaged that the invention can be further adapted so that the ancillary information offered is customised according to the viewer's likely interests. For example the invention can present links to further information about cars in a scene if the viewer is male but present links connecting items of clothing in the scene to fashion suppliers if the viewer is female.

In some implementations of the invention, the linking information is stored locally in the television receiver or DVR. In other implementations the linking information is stored in a remote server. It may also be preferable, in some cases, that the linking information is shared across both local and remote storage. For example, if there are several scene changes during the period in which the “i” icon is displayed, it may be desirable to store the information relating to the most likely scene selection locally and refer to a remote server if the information request is made based on a different scene which is less likely to be selected.

In some embodiments the metadata mapping the television program to advertising hyperlinks is embedded within the program itself. In other embodiments the metadata is supplied as separate information linked to the associated television program by reference, for example by time of broadcast or time offset within the program.

1. An interactive television method comprising the steps of displaying a television program, displaying an information icon, receiving an information command from a viewer of said program, freezing display of said program, superimposing an image indicating selectable fields on one or more items of the image on said frozen display, receiving navigation commands from the viewer, moving a cursor between said selectable fields according to said received navigation commands, receiving a confirmation command from the viewer, and, responsive to which selectable field is selected by said cursor, displaying supplementary information.

2. An interactive television method comprising the steps of displaying a television program, displaying an information icon, receiving an information command from a viewer of said program, replacing the display of said program with a graphic image mimicking the scene at the point at which said information command was received, said graphic image comprising selectable fields corresponding to items for which supplemental information is available, receiving navigation commands from the viewer, moving a cursor between said selectable fields according to said received navigation commands, receiving a confirmation command from the viewer, and, responsive to which selectable field is selected by said cursor, displaying supplementary information.
